(19) United States
(12) Patent Application Publication
(10) Pub. No.: US 2010/0101780 A1
(43) Pub. Date: Apr. 29, 2010

(54) PROCESS OF APPLYING HARD-FACING ALLOYS HAVING IMPROVED CRACK RESISTANCE AND TOOLS MANUFACTURED THEREFROM

(76) Inventors: Michael Drew Ballew, Casper, WY (US); John Robert Ballew, Casper, WY (US); Ravi Menon, Goodlettsville, TN (US); Jack Gary Wallin, Scottsville, KY (US); Francis Louis LeClaire, Bowling Green, KY (US)

Correspondence Address: Brinks Hofer Gilson & Lione/Ann Arbor, 524 South Main Street, Suite 200, Ann Arbor, MI, 48104, US

(21) Appl. No.: 12/609,285

(22) Filed: Oct. 30, 2009

Related U.S. Application Data
(63) Continuation-in-part of application No. 11/356,409, filed on Feb. 16, 2006.

(51) Int. Cl. E21B 17/04; B23K 9/04; F16L 25/00; E21B 17/02; B32B 15/01

(52) U.S. Cl. 166/242.6; 219/76.1; 219/76.14; 285/422; 428/685

(57) ABSTRACT

Industrial tools having an outer diameter surface protected from abrasion due to silicious materials present in the Earth's crust by a layer of a hard-facing alloy with improved crack resistance, improved wear resistance, and improved hardness are provided. Additionally, a process for applying the hard-facing alloy to the surface of the industrial tools is described.

### CROSS REFERENCE TO RELATED APPLICATION

This application is a continuation-in-part of U.S. application Ser. No. 11/356,409 filed Feb. 16, 2006, the entire contents of which are hereby incorporated by reference.

### FIELD

The present disclosure relates to industrial tools having a surface exposed to abrasion that is protected by the application of hard surfacing alloys. The hard surfacing alloys are typically applied via arc welding, and their compositions contribute to reduced cracking and to increased wear resistance and hardness.

### BACKGROUND

The statements in this section merely provide background information related to the present disclosure and may not constitute prior art.

In a conventional oil and gas drilling operation, multiple pipe sections, securely connected together by tool joints and having a bit at a lower end, are rotated to bore a hole into the surface of the earth. A casing having an inside diameter large enough for passage of the pipe sections, tool joints, and bit is used to hold the earth in place, thereby, preventing it from collapsing onto the rotating pipe sections. The casing also prevents the fluid circulated through the pipe sections, as well as the earth that exists in the annulus created between the pipe sections and casing, to flow back into the hole that is being bored.

There exists a continuing issue related to the service life of the tool joints because most of the Earth's crust is composed of very abrasive, silicious materials. These silicious materials can cause considerable wear on the tool joints, particularly a box member (i.e., raised protective casing) surrounding the tool joint. Similarly, other industrial tools exposed to the abrasive silicious materials present in the Earth's crust will encounter abrasive wear and a reduced useful life-time.

One solution to the wear of tool joints is hard-facing. Hard-facing relates generally to techniques or methods of applying a hard, wear resistant alloy to the surface of a substrate, such as a tool joint, to reduce wear caused by abrasion, erosion, corrosion, and heat, among other operational or environmental conditions. Historically, the industry has utilized a layer of tungsten carbide as a hard-facing material. Unfortunately, tungsten carbide is an expensive material that has been observed to erode quickly and when used in a drilling operation, induces abrasive wear of the soft steel casing.

Another hard-facing material that has been commonly used is chromium carbide. This material is usually applied economically to a substrate through a welding process. Although a weld deposit comprised of chromium carbide provides good wear resistance, this type of weld deposit typically exhibits a cross-checking pattern in its surface. Such cross-checking is undesirable due to an increased susceptibility to crack formation. Additionally, the coarse chromium carbide grains present in the weld deposit may contribute to the occurrence of check-cracking, which are cracks that develop perpendicular to a bead direction and accelerate abrasive wear.

Therefore, hard-faced industrial tools and economic methods of hard-facing such industrial tools that will provide a surface harder than the silicious materials present in the Earth's crust are continuously desired. It is further desirable that such hard-faced tools exhibit exceptional resistance to the formation of cracks and improved wear resistance.

### SUMMARY

The present disclosure provides tools and processes to improve the service life of industrial tools exposed to abrasion by silicious materials present in the Earth's crust. In one form of the present disclosure, the industrial tool relates to the tool joint that connects two sections of pipe together and is subsequently used to bore or drill a hole into the Earth's crust.

In this form of the present disclosure, the outer surface of the industrial tool that will be subjected to abrasion by the silicious materials is protected by a hard-face material or alloy. This hard-face alloy is comprised of about 0.7% to about 2.0% Carbon, about 0.2% to about 0.5% Manganese, about 0.5% to about 1.1% Silicon, about 2.0% to about 8.0% Chromium, about 2.0% to about 6.0% Molybdenum, about 2.0% to about 8.0% Niobium and Titanium, about 1.0% to about 2.5% Vanadium, about 0.2% to about 0.9% Boron, and about 2.0% to about 5.0% Tungsten by mass with the balance being comprised of Iron. Preferably, this alloy is comprised of about 1.1% Carbon, about 0.3% Manganese, about 0.8% Silicon, about 4.0% Chromium, about 4.0% Molybdenum, about 3.5% Tungsten, about 3.2% Niobium and Titanium, about 1.8% Vanadium, and about 0.5% Boron by mass with the balance being Iron.

In another form of the present disclosure the outer surface of the industrial tool that will be subjected to abrasion by silicious materials is protected by a hard-face alloy comprised of about 0.7% to about 2.0% Carbon, about 0.1% to about 0.5% Manganese, about 0.7% to about 1.4% Silicon, about 6.0% to about 11.0% Chromium, about 0.5% to about 2.0% Molybdenum, about 2.0% to about 8.0% Niobium and Titanium, about 0.2% to about 1.0% Vanadium, about 0.2% to about 0.9% Boron, and about 0.4% to about 0.8% Copper by mass with the balance being comprised of Iron. Preferably, this alloy is comprised of about 1.1% Carbon, about 0.2% Manganese, about 1.0% Silicon, about 9.0% Chromium, about 0.8% Molybdenum, about 0.6% Copper, about 3.5% Niobium and Titanium, about 0.3% Vanadium, and about 0.5% Boron by mass with the balance being Iron.

In general, weld deposits with improved crack resistance, improved wear resistance, and improved hardness are provided by using nucleation sites to control matrix grain size and by balancing Titanium and/or Niobium with Carbon and/or Boron content. In one form of the present disclosure, the amount of titanium in the alloy is preferably about four times the amount of Carbon and the amount of Niobium in the alloy is preferably about eight times the amount of Carbon. In yet another form of the present disclosure the ratio of Niobium to Boron in the alloy is preferably about 8.6 and the ratio of Titanium to Boron in the alloy is preferably about 4.4.

The present disclosure also provides a method for applying the hard-facing alloy or material to the surface of an industrial tool. Preferably, a weld deposit is applied to an elevated outer diameter surface of an industrial tool having a box end and a pin end that can be reversibly connected to each other. This method of creating the weld deposit comprises the steps of inspecting and cleaning the surface of the tool; pre-heating the surface of the tool; applying at least one weld band of the hard-face alloy or material of the present disclosure to the box end of the tool; applying at least one weld band of the same hard-face material to the pin end of the tool; welding said weld bands to the box end and pin end of the tool; and cooling said welded bands at a rate of less than about 75 degrees Fahrenheit per hour.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of one form of the present disclosure representing the box end and pin end of a tool joint used to connect sections of a drill pipe in accordance with the teachings of the present disclosure;

FIG. 2(A) is a perspective view of one form of the present disclosure where a substantially flush outer cylindrical surface results when the box end and pin end of a tool joint are connected;

FIG. 2(B) is a perspective view of a weld deposit as applied to a drill pipe having a flush outer cylindrical surface when the box end and pin end of a tool joint are connected;

FIG. 3(A) is a perspective view of another form of the present disclosure where a recess has been formed in the area to which a weld deposit will be applied when the box end and pin end of a tool joint are connected;

FIG. 3(B) is a perspective view of a weld deposit as applied to a tool joint having a recessed outer cylindrical surface when the box end and pin end are connected creating a substantially flush outer surface up to the shoulder of the joint;

FIG. 3(C) is a perspective view of a weld deposit as applied to a tool joint having a recessed outer cylindrical surface when the box end and pin end are connected creating a substantially flush outer surface overlapping the shoulder of the joint;

FIG. 4 is a perspective view of a tool joint having a collar connecting two pin ends of a pipe.

FIG. 5(A) is a photomicrograph of Weld Deposit A applied on top of a worn layer of a chromium carbide hard-facing exhibiting a matrix having a fine grain size in accordance with the teachings of the present disclosure;

FIG. 5(B) is a photomicrograph of Weld Deposit B applied on top of a worn layer of a chromium carbide hard-facing exhibiting a matrix having a fine grain size in accordance with the teachings of the present disclosure; and

FIG. 6 is a photomicrograph of Weld Deposit B applied on top of a worn layer of Weld Deposit A exhibiting a matrix having a fine grain size in accordance with the teachings of the present disclosure.

### DETAILED DESCRIPTION

The following description is merely exemplary in nature and is in no way intended to limit the present disclosure or its application or uses. It should be understood that throughout the description and drawings, corresponding reference numerals indicate like or corresponding parts and features.

The present disclosure relates to industrial tools having a surface, which is protected when exposed to abrasive conditions, by the presence of a weld deposit having specific characteristics. The presence of this weld deposit is found to impart exceptional resistance to the formation of cracks, improved wear resistance, and improved hardness to the surface of the tool. The weld deposit characteristics include a matrix having a fine grain size, small evenly dispersed carbides within the matrix, and a small amount of Carbon in the matrix, as well as the presence of several other alloying elements that further enhance various properties exhibited by the weld deposit as described in greater detail below.

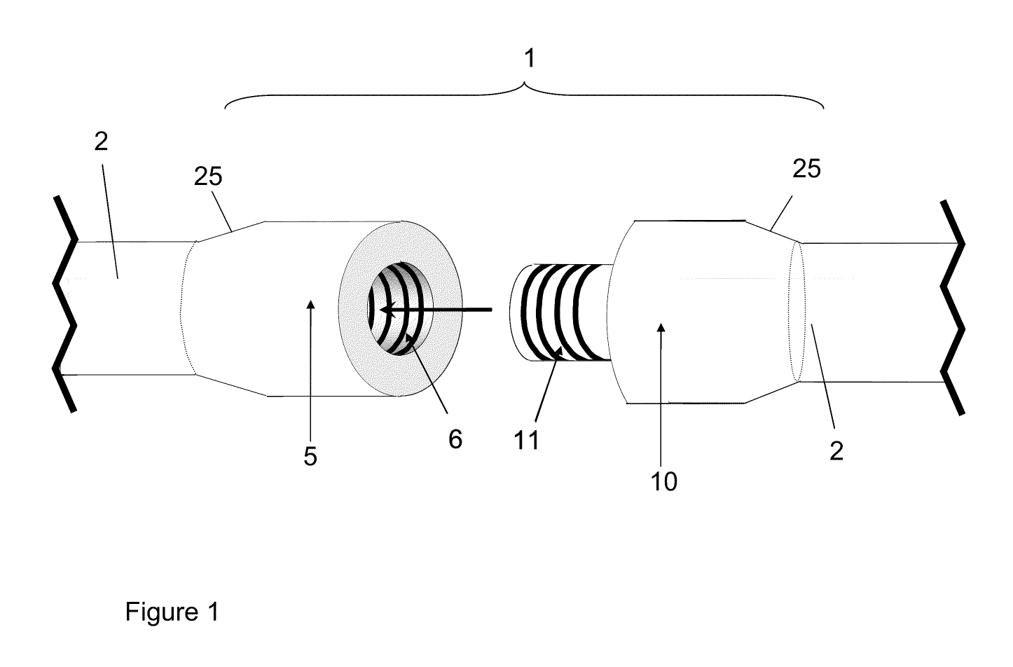

Referring to FIG. 1, one form of the present disclosure relates to a tool joint 1 for connecting together two sections of a drill pipe 2 used in the drilling of water, gas, and other wells, where one section of the pipe has a box end 5 for connecting with a second section of the pipe having a pin end 10. The box end 5 may be internally threaded 6 to interact with threads 11 present on the pin end 10.

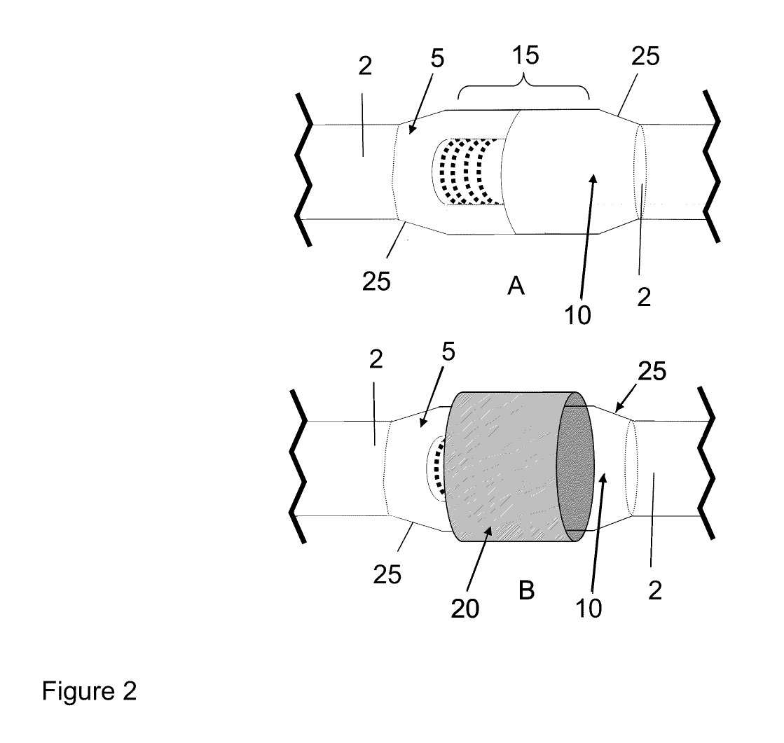

Referring to FIG. 2A, when connected, cylindrical outer surface 15 of the box end 5 and the pin end 10 may become substantially flush with each other. As shown in FIG. 2B, in this form, a layer of hard-facing material or alloy 20 is applied as a weld deposit on to the substantially flush cylindrical surface 15, thereby raising the external cylindrical surface surrounding the tool joint. The hard-facing material can be applied onto the box end 5 of the tool joint 1 starting about 0.25 inches (0.64 cm) to abut 0.375 (0.952 cm) inches away from shoulder 25 of the tool 2. Hard-facing material applied in this form reduces casing wear by reducing the surface area in contact with the casing in which the tool is used. However, the application of a weld deposit to a tool in this manner may encounter some difficulty if used in applications in which there is little tolerance or a tight fit between the tool and the casing or hole in which the tool is used.

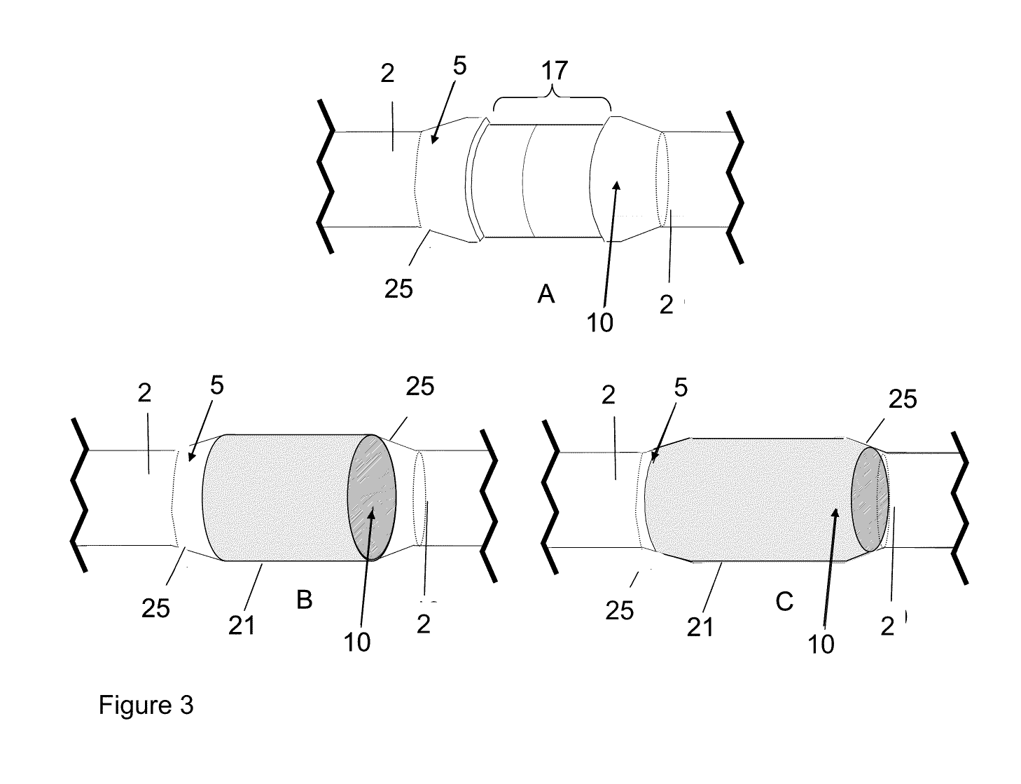

Referring now to FIG. 3A, in another form of the present disclosure, the outer cylindrical surface 15 of the box end 5 and pin end 10 may be reduced (e.g., by machining, casting, etc.) to remove a band of material, thereby, creating a recess 17. The recess 17 created on the outer surface 15 of the tool joint 1 is preferably about 0.09 inches (0.23 cm) in depth. As shown in FIG. 3B, in this form an outer cylindrical surface of the hard-facing material 21 when applied as a weld deposit is substantially flush with the outer cylindrical surface of the tool joint near its surface. As shown in FIG. 3C, another form of the disclosure includes the hard-facing material may be applied to cover all or a portion of the shoulder 25 that the tool joint 1 makes with the pipe. This form is anticipated to be useful in those applications where there is little tolerance or a relatively tight fit between the tool and the casing or hole in which the tool will be used.

In one form, the hard-facing material is applied to the outer cylindrical surface 15, 17 of the tool joint 1 as a plurality of transversely extending weld bands or beads. The bands may be on the order of about 1 inch (2.5 cm) to about 3 inches (7.6 cm) in width. The application of 3 inch wide bands is preferred on the box end 5 of the tool joint 1, while about 1 to 2 inch bands is preferred on the pin end 10 of the tool joint 1. The overall length of the tool joint may be between about 30 inches (76 cm) to about 60 inches (152 cm). Also the bands as applied may be about 0.09 inches (0.23 cm) in overall thickness, although the user of the tool may specify other thicknesses. Bands may be applied on top of each other in order to build-up to the desired thickness. The number of bands applied to the tool joint is determined by the spacing provided by the length of the tool joint. An overall width of the weld deposit is preferably greater than about 6.5 inches (16.5 cm) in order to accommodate tong spacing.

The weld band profile and band overlap contribute to the performance of the finished weld deposit. An improper band profile may lead to severe concavity or convexity within the weld deposit resulting in the necessity of making difficult and time consuming repairs to the weld deposit. The weld bands should be applied relatively flat to slightly convex with about a 0.06 inch (0.15 cm) to about 0.12 inch (0.30 cm) overlap between the bands.

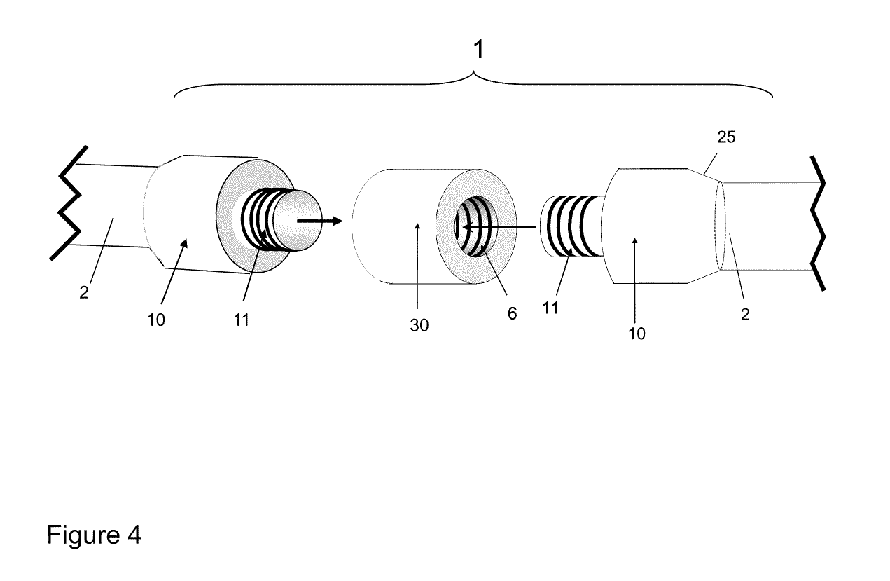

Referring to FIG. 4, in addition to a tool joint 1 for well drilling as previously described, the hard-facing material of the present disclosure may be applied separately to connecting collars 30 known to those skilled in the art, and subsequently used to connect multiple sections of pipe together via a tool joint 1. In addition to pipe tool joints, the hard-facing materials of the present invention can be applied to other industrial tools that will be exposed to the abrasive silicious materials found in the Earth's crust. Therefore, the specific geometries and dimensions as set forth herein are merely exemplary and should not be considered as limiting the scope of the present disclosure.

One weld deposit of the present disclosure is an alloy comprised of the elements: Carbon (C), Manganese (Mn), Silicon (Si), Chromium (Cr), Niobium (Nb), Titanium (Ti), Vanadium (V), Molybdenum (Mo), Boron (B), Tungsten (W) and Iron (Fe). Due to cost or when Molybdenum is present in a relatively high percentage in the alloy composition, the element Tungsten (W) may be replaced by the element Copper (Cu). The elements of Carbon, Manganese, Silicon, Chromium, Niobium, Titanium, Vanadium, Molybdenum, Boron and either Tungsten or Copper typically comprise between about 4.8 percent and about 33.8 percent of the alloy by mass with the balance being comprised of Iron.

Carbon (C) is an element that improves hardness and strength of the weld deposit. The amount of Carbon in the weld deposit is between about 0.7 and about 2.0 percent, with about 1.1 percent being preferred.

Manganese (Mn) is an element that improves hardness, toughness and acts as a deoxidizer in the weld deposit. Manganese also acts as a grain refiner. The amount of manganese in the weld deposit is between about 0.1 and about 0.5 percent, with about 0.2 to about 0.3 percent being preferred.

Silicon (Si) is an element that acts as a deoxidizer to improve corrosion resistance and may also act as a grain refiner. The preferred amount of Silicon in the weld deposit is between about 0.5 and 1.4 percent, with about 0.8 to about 1.0 percent being preferred.

Chromium (Cr) is an element that provides the weld deposit with depth of hardenability, corrosion resistance, carbide/boride formation, and improved high temperature creep strength. The amount of Chromium in the weld deposit is between about 2.0 and about 11.0 percent, with between about 4.0 and 9.0 percent being preferred.

Molybdenum (Mo) is an element that provides improved tensile strength of the weld deposit as carbide, boride, or a solid-solution strengthener. Tungsten and molybdenum act as solid-solution strengtheners. Tungsten and molybdenum can be substituted for each other in many cases, but the molybdenum is more effective at increasing matrix strength and hardness. The amount of molybdenum in the weld deposit is between about 0.5 percent and about 6.0 percent, with between about 0.8 percent and about 4.0 percent being preferred.

Tungsten (W) is an element that provides improved creep strength of the weld deposit. The preferred amount of tungsten in the weld deposit is between about 2.0 percent and about 5.0 percent, with about 3.5 percent being preferred. When molybdenum is present in the alloy in excess of about 2.0 percent, the element Tungsten may be replaced in the weld deposit with the element Copper (Cu). A preferred alloy composition of the present invention does not comprise any Copper.

Copper (Cu) is an alloying element that can be used in steels to modify the structure by providing a secondary phase to partition/refine grains or by depressing the freezing point of the austenite phase for a shorter freezing range. The shorter freezing range means that less shear strain is exerted on the phase due to the coefficient of thermal expansion/contraction. In effect, there is less strain due to the contraction that occurs upon cooling because the austenite is cooled through only half of its normal freezing range. Since austenite is prone to hot tearing, targeting this phase to avoid any excess shear stresses greatly reduces this failure mechanism in the alloy. When present, the amount of Copper in the weld deposit is between about 0.4 percent and about 0.8 percent, with about 0.6 percent being preferred.

Vanadium (V), which is a secondary, carbide former and a grain refiner, increases the toughness of the weld deposit. The amount of Vanadium in the weld deposit is between about 0.2 percent and about 2.5 percent, with between about 0.3 percent and about 1.8 percent being preferred.

Boron (B) is an element that provides interstitial hardening in the matrix, strengthens the grain boundaries by accommodating mismatches due to incident lattice angles of neighboring grains with respect to the common grain boundary, and by itself or in combination with Carbon, form nucleation sites as intermetallics with Titanium and/or Niobium in the weld deposit. The amount of Boron in the weld deposit is between about 0.2 percent and about 0.9 percent, with about 0.5 percent being preferred.

Titanium (Ti) and Niobium (Nb) act as grain refiners, deoxidizers, and primary carbide/boride formers in the weld deposit. The amounts of Titanium and Niobium are balanced with the amount of Carbon/Boron as set forth above in order to reduce the amount of Carbon/Boron in the weld metal matrix and grain boundaries, which reduces the possibility of cracking and improves the toughness of the hard-facing surface. The ratios of the elements are based on the atomic weights and the type of intermetallic carbide/boride desired. The Titanium is generally four times the mass of Carbon, and the niobium is generally eight times the mass of Carbon. Any excess Carbon is left to the secondary carbide formers and the matrix. The ratio of the Titanium to Boron is preferably about 4.4 for Titanium Boride and about 2.2 for Titanium Diboride. The Niobium/Boron ratio is preferably about 8.6 for Niobium Boride and about 4.3 for Niobium Diboride. The Titanium/Niobium and the Carbon/Boron pairs are substitutional in nature, and thus deviations from these ratios can be tolerated and should be construed as falling within the scope of the present disclosure. Additionally, particles of these elements freeze at a very high temperature and are therefore considered primary carbides/borides.

The Titanium and Niobium when combined with Carbon and/or Boron will act as grain refiners to provide nucleation sites for the formation of many small grains, which contribute to improved crack resistance. Additionally, the small grains improve ductility and reduce hot tearing by increasing the grain boundary area and reducing the average distance that the grains have to slide against each other to accommodate the local strain induced by shrinkage due to cooling. The grain boundary sliding is known as shear, which is generally responsible for hot-tearing in the grain boundaries.

Two exemplary alloy compositions for use as hard-facing on the tools of the present invention include the compositions described in related U.S. patent application Ser. No. 11/356,409 (filed Feb. 16, 2006) as Weld Deposits A and B. The ranges in percent mass associated with the elements that comprise these two alloys along with the target percent mass are provided in Table 1 below.

In one form, the weld deposit is produced from the use of a welding wire or bands, which may include a solid wire, metal-cored wire or a flux-cored wire. A metal-cored wire may generally comprise a metal sheath filled with a powdered metal alloy and a flux-cored wire may generally comprise a mixture of powdered metal and fluxing ingredients. Accordingly, flux-cored and metal-cored wires offer additional versatility due to the wide variety of alloys that can be included within the powdered metal core in addition to the alloy content provided by the sheath. One skilled in the art would understand that other types of welding consumables such as a solid wire or coated shielded metal arc electrodes may also be employed while remaining within the scope of the present disclosure. When welded onto a substrate, the resulting weld deposit produces a welded structure having improved crack resistance, wear resistance, and hardness.

TABLE 1

| | |
|---|---|
| Weld | |
| Deposit A | Weld Deposit B |

| | | Target | Range | Target |
|---|---|---|---|---|
| | Range | (~% | (~% | (~% |
| Element | (~% mass) | mass) | mass) | mass) |
| C | 0.7-2.0 | 1.1 | 0.7-2.0 | 1.1 |
| Mn | 0.2-0.5 | 0.3 | 0.1-0.5 | 0.2 |
| Si | 0.5-1.1 | 0.8 | 0.7-1.4 | 1.0 |
| Cr | 2.0-8.0 | 4.0 | 6.0-11.0 | 9.0 |
| Mo | 2.0-6.0 | 4.0 | 0.5-2.0 | 0.8 |
| W | 2.0-5.0 | 3.5 | 0 | 0 |
| Nb, Ti | 2.0-8.0 | 3.2 | 2.0-8.0 | 3.5 |
| V | 1.0-2.5 | 1.8 | 0.2-1.0 | 0.3 |
| B | 0.2-0.9 | 0.5 | 0.2-0.9 | 0.5 |
| Cu | 0 | 0 | 0.4-0.8 | 0.6 |
| Fe | Balance | Balance | Balance | Balance |

The compositions of the weld deposits according to the teachings of the present disclosure are formulated to reduce the amount of cross-checking as compared with other martensitic and tool steel welding wire deposits while improving wear resistance. In exemplary testing, the composition of the weld deposits of the present invention have shown improved hardness and reduced weight loss when compared to other weld deposits.

The hard-facing material of the present disclosure may be applied onto the surface of new tools or tools having a surface comprising another worn hard-face material. The tools to which the hard-face material is applied are typically metallic in nature with steels having less than about 1 percent carbon. Examples of base metals to which the hard-face materials of the present disclosure may be applied include, but are not limited to, stainless steels, manganese steels, cast iron and iron steels, nickel-based alloys, and copper-based alloys. Examples of several hard-face materials over which the hard-face materials of the present disclosure may be applied include, but are not limited to, tungsten carbide, martensitic, and chromium carbide deposits, with TCS-8000 (Liquidmetal Technologies, California) and Armacor™ M (National Oilwell Varco, Texas) being two specific examples of such materials. Furthermore, after a tool protected from wear by the hard-face materials of the present disclosure is used and the hard-face material becomes substantially worn, another layer of a hard-face material may be reapplied to the tool's surface according to the procedure described herein.

The hard-facing materials of the present disclosure were evaluated against typical chromium-based and martensitic hard-facing materials using a modified ASTM G77 block and ring wear test. In this test a fixed block of hard-facing material is forced into contact with a rotating ring comprised of a casing material in the presence of a mud-like slurry. The resulting weight loss of the block and/or ring are suggested to represent the wear characteristics indicative of the material combination when applied and used on a tool joint in a well drilling application. In the tests performed using this test, the casing material was selected to be steel grade N80 and the slurry to consist of 4.7% Bentonite, 21.3% silica sand, and 74.0% water by mass. The hard-facing materials of the present invention when applied to an alloy steel (Grade 4140) were found to out perform the conventional chromium carbide and martensitic deposits by lowering the amount of wear exhibited by the hard-facing material as shown in Table 2. More specifically, a reduction of about 40% in the wear encountered by the hard-facing material is observed to occur when using the hard-facing materials of the present invention.

TABLE 2

| | Hard-Facing |
|---|---|
| | Weight Loss |
| | (gms) |
| Chromium-based alloy | 0.0145 |
| Martensitic Deposit | 0.0159 |
| Weld Deposit A | 0.0080 |
| Weld Deposit B | 0.0098 |

Another form of the present disclosure corresponds to a process for applying the hard-facing material as a weld deposit to the outer surface of industrial tools. An inspection of the outer surface area upon which the hard-facing material will be applied may be done prior to applying said material. Such initial inspection may focus upon establishing the characteristics of the tool and tool material, including but not limited to the weight, grade, and dimensions of the tool. The outer surface of the tool may be cleaned of debris, rust, paint, lubricants, and other foreign matter or contaminants using a side-grinder with a wire wheel, sand blasting, water blasting, or other means known to a person skilled in the art. If the tool has previously been used, the condition of the tool and the type of residual hard-facing material left on the surface of the tool may preferably be examined and identified to insure compatibility with the hard-facing material of the present disclosure.

In one form, the tool is preheated prior to the application of the weld wire material of the present disclosure. Any means of establishing a uniform surface temperature on the surface of the tool known to someone skilled in the art is acceptable for preheating the tool. Examples of several available methods include gas burners and induction heaters. If welding in a cold or wet weather environment, a minimum preheat temperature of about 175 degrees Fahrenheit (79° C.) may be applied to remove any adsorbed or absorbed water on or near the tool's outer surface. In one form, the surface of the tool is preheated to between about 450 to about 500 degrees Fahrenheit (232 to 260° C.). If the tool has an internal plastic coating, water may be passed through the inner diameter of the tool in order to minimize the temperature to which the coating is exposed. The preheating of the outer surface of tools having an internal plastic coating should not exceed about 700 degrees Fahrenheit (371° C.) in order to reduce the chance of blistering or cracking the internal coating. The preheat temperature may be measured by a contact electronic pyrometer, the use of tempstiks or thermal crayons, or any other method known to someone skilled in the art.

The wire band may be welded to the surface of the tool using arc welding, torch welding, or any other welding technique known to a person skilled in the art of welding. Examples of possible welding processes include, but are not limited to, flux core arc welding (FCAW), gas metal arc welding (GMAW), plasma arc welding (PAW), shielded metal arc welding (SMAW), submerged arc welding (SAW), oxy/fuel gas welding (OFW), electron beam welding (EBW), and laser beam welding (LBW). Welding equipment in which the torch angle or the offset from vertical center can be adjusted may be utilized to enhance the consistency of the bead profile. In order to insure that the weld deposit does not develop excessive porosity resulting from the incorporation of impurities due to slag being present on a torch nozzle, the present disclosure provides for routine inspection, cleaning, and application of an anti-spatter material to any torch used in the welding process.

After welding, the weld deposit and tool are cooled at a rate less than or equal to about 75 degrees Fahrenheit (24° C.) per hour. The use of cooling blankets is preferred unless the operation is being done in an environment that is wet or colder than about 32 degrees Fahrenheit (0° C.). However, other methods of cooling, such as the use of cool cans may be utilized. Preferably, the inner diameter of the tool is plugged with insulation during the cool down process.

The weld deposit is finally inspected to determine overall weld quality. Any spatter, flux, or other protrusions may be removed via a chisel, grinding, or using another method known to those persons skilled in the art. The presence of any pinholes in excess of about 0.06 inches (0.15 cm) in radius may be repaired by spot welding. The presence of any cracks propagating into the tool material, any axial cracking in the weld deposit that is less than about 0.5 inches (1.3 cm) apart, or any cracking in the center of an individual band that exceeds 180 degrees should be avoided.

The following specific examples are given to further illustrate the invention and should not be construed to limit the scope of the invention.

### Example 1

### New Weld Deposit Over Worn Chromium Carbide Layer

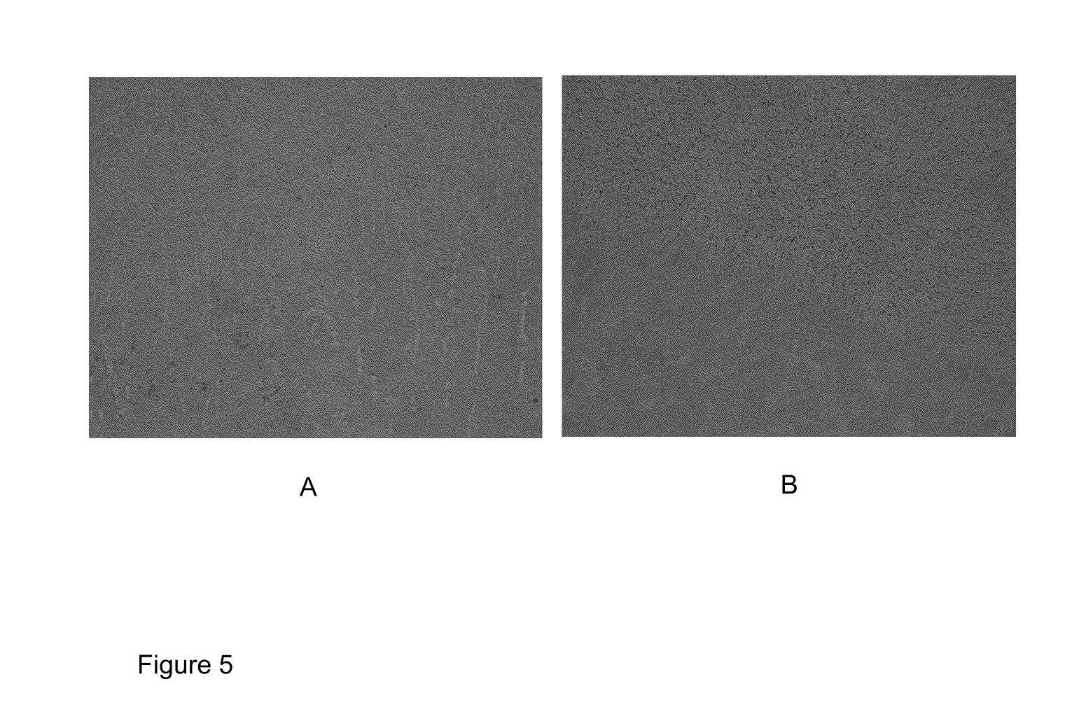

Two tools comprising a worn layer of a typical chromium carbide hard-face material was subjected to the hard-facing procedure of the current disclosure and a new layer of one the hard-facing materials identified in Table 1 was applied to each tool. The resulting Weld Deposits, A and B, applied on the worn layer both exhibited a fine grain microstructure with no cracks or porosity being present as shown in FIGS. 5 (A & B).

### Example 2

### New Weld Deposit Over Worn Weld Deposit

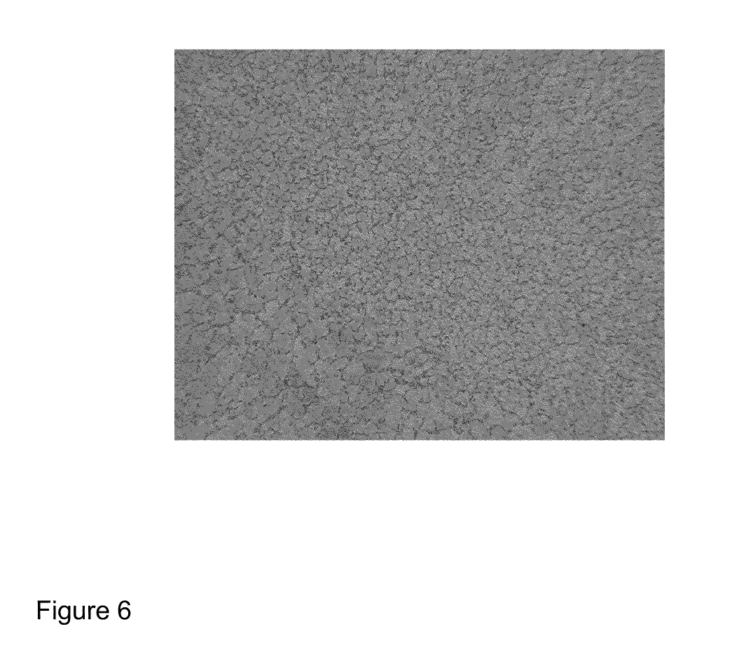

A tool comprising a worn layer of Weld Deposit A (Table 1) was subjected to the hard-facing procedure of the current invention and a new layer of Weld Deposit B was applied. The resulting Weld Deposit B exhibited a fined grain microstructure with no cracks or porosity being present as shown in FIG. 6.

A person skilled in the art will recognize from the previous description that modifications and changes can be made to the present disclosure without departing from the scope of the disclosure as defined in the following claims. A person skilled in the art will further recognize that the wear and weight loss measurements described are standard measurements that can be obtained by a variety of different test methods. The test methods described in the examples represents only one available method to obtain each of the required measurements.

What is claimed is:

1. An industrial tool having an outer surface subjected to abrasion comprising:
a layer of a hard-facing alloy deposited on said surface,
wherein said alloy is comprised by percent mass of
about 0.7% to about 2.0% Carbon,
about 0.2% to about 0.5% Manganese
about 0.5% to about 1.1% Silicon,
about 2.0% to about 8.0% Chromium,
about 2.0% to about 6.0% Molybdenum,
about 2.0% to about 8.0% Niobium and Titanium,
about 1.0% to about 2.5% Vanadium,
about 0.2% to about 0.9% Boron, and
about 2.0% to about 5.0% Tungsten
with the balance being comprised of Iron.

2. The industrial tool of claim 1, wherein the surface subjected to abrasion is a tool joint used to connect together two sections of a drill pipe.

3. The industrial tool of claim 1, wherein the surface subjected to abrasion is a connecting collar used to connect together two sections of a drill pipe.

4. The industrial tool of claim 1, wherein the alloy comprises about 1.1% Carbon, about 0.3% Manganese, about 0.8% Silicon, about 4.0% Chromium, about 4.0% Molybdenum, about 3.5% Tungsten, about 3.2% Niobium and Titanium, about 1.8% Vanadium, and about 0.5% Boron by mass with the balance being Iron.

5. The industrial tool of claim 1, wherein the amount of titanium in the alloy is about four times the amount of Carbon and the amount of Niobium in the alloy is about eight times the amount of Carbon.

6. The industrial tool of claim 1, wherein the ratio of Niobium to Boron in the alloy is about 8.6 and the ratio of Titanium to Boron in the alloy is about 4.4.

7. An industrial tool having an outer surface subjected to abrasion comprising:
a layer of a hard-facing alloy deposited on said surface,
wherein said alloy is comprised by percent mass of
about 0.7% to about 2.0% Carbon,
about 0.1% to about 0.5% Manganese
about 0.7% to about 1.4% Silicon,
about 6.0% to about 11.0% Chromium,
about 0.5% to about 2.0% Molybdenum,
about 2.0% to about 8.0% Niobium and Titanium,
about 0.2% to about 1.0% Vanadium,
about 0.2% to about 0.9% Boron, and
about 0.4% to about 0.8% Copper
with the balance being comprised of Iron.

8. The industrial tool of claim 7, wherein the surface subjected to abrasion is a tool joint used to connect together two sections of a drill pipe.

9. The industrial tool of claim 7, wherein the surface subjected to abrasion is a connecting collar used to connect together two sections of a drill pipe.

10. The industrial tool of claim 7, wherein the alloy comprises about 1.1% Carbon, about 0.2% Manganese, about 1.0% Silicon, about 9.0% Chromium, about 0.8% Molybdenum, about 0.6% Copper, about 3.5% Niobium and Titanium, about 0.3% Vanadium, and about 0.5% Boron by mass with the balance being Iron.

11. The industrial tool of claim 7, wherein the amount of titanium in the alloy is about four times the amount of Carbon and the amount of Niobium in the alloy is about eight times the amount of Carbon.

12. The industrial tool of claim 7, wherein the ratio of Niobium to Boron in the alloy is about 8.6 and the ratio of Titanium to Boron in the alloy is about 4.4.

13. A method of applying a weld deposit to an outer surface of an industrial tool having a box end and a pin end that may be reversibly connected with each end having a shoulder, said method comprising the steps of:
inspecting and cleaning the surface of the tool;
pre-heating the surface of the tool;
applying at least one weld band to the box end of the tool;
applying at least one weld band to the pin end of the tool;
wherein said weld bands are comprised of the elements including carbon manganese, silicon, chromium, molybdenum, tungsten, niobium, titanium, vanadium, boron, and iron;
welding said weld bands to the box end and pin end of the tool; and
cooling said welded bands at a rate of less than about 75 degrees Fahrenheit per hour.

14. The method of claim 13, wherein the outer diameter surface of the tool is machined between the shoulders of the box end and pin end to create a groove having a depth of about 0.94 inches into which the weld bands are deposited.

15. The method of claim 14, wherein the deposited weld bands are substantially flush with the shoulder of the box end and pin end of the tool.

16. The method of claim 14, wherein the deposited weld bands overlap the shoulder of the box end and pin end of the tool.

17. The method of claim 13, wherein the industrial tool further comprises a connecting collar used to overlap and reversibly connect the box end and pin end.

18. The method of claim 17, wherein the weld bands are applied to the connecting collar.

19. The method of claim 13, wherein the surface of the tool is preheated to a temperature greater than about 175 degrees Fahrenheit.

20. The method of claim 19, wherein the surface of the tool is preheated to a temperature between about 450 to about 500 degrees Fahrenheit.

21. The method of claim 13, wherein the weld bands applied to the box end of the tool are about 3 inches in width.

22. The method of claim 13, wherein the weld bands applied to the pin end of the tool are between about 1 inch and about 2 inches in width.

23. The method of claim 13, wherein the weld bands applied to the box end and the weld bands applied to the pin end are about 0.09 inches in overall thickness.

24. The method of claim 13, wherein the weld bands overlap each other by about 0.06 inches to about 0.12 inches.

25. The method of claim 13, wherein the cooling is accomplished via the use of cooling blankets, cooling cans, or insulation.

26. The method of claim 13, wherein the weld bands are comprised of about 0.7% to about 2.0% Carbon, about 0.2% to about 0.5% Manganese, about 0.5% to about 1.1% Silicon, about 2.0% to about 8.0% Chromium, about 2.0% to about 6.0% Molybdenum, about 2.0% to about 8.0% Niobium and Titanium, about 1.0% to about 2.5% Vanadium, about 0.2% to about 0.9% Boron, and about 2.0% to about 5.0% Tungsten by mass with the balance being comprised of Iron.

27. The method of claim 13, wherein the weld bands are comprised of about 0.7% to about 2.0% Carbon, about 0.1% to about 0.5% Manganese, about 0.7% to about 1.4% Silicon, about 6.0% to about 11.0% Chromium, about 0.5% to about 2.0% Molybdenum, about 2.0% to about 8.0% Niobium and Titanium, about 0.2% to about 1.0% Vanadium, about 0.2% to about 0.9% Boron, and about 0.4% to about 0.8% Copper by mass with the balance being comprised of Iron.
